(19) United States
(12) Patent Application Publication
(10) Pub. No.: US 2017/0006774 A1
(43) Pub. Date: Jan. 12, 2017

(54) Interchangeable Blade Assembly

(71) Applicants: Johnny V. Benavides, Millsap, TX (US); Michael Kinman, Millsap, TX (US)

(72) Inventors: Johnny V. Benavides, Millsap, TX (US); Michael Kinman, Millsap, TX (US)

(21) Appl. No.: 14/795,942

(22) Filed: Jul. 10, 2015

(51) Int. Cl. A01D 34/73

(52) U.S. Cl. CPC A01D 34/73

(57) ABSTRACT

An interchangeable blade assembly for quickly coupling a plurality of blades on landscaping equipment includes a disk operationally coupled to the landscaping equipment. The disk is moved by the landscaping equipment. A blade is operationally coupled to the disk. The blade is moved by the disk so the blade may cut plant matter.

### BACKGROUND OF THE DISCLOSURE

### Field of the Disclosure

The disclosure relates to interchangeable blade devices and more particularly pertains to a new interchangeable blade device for quickly coupling a plurality of blades on landscaping equipment.

### SUMMARY OF THE DISCLOSURE

An embodiment of the disclosure meets the needs presented above by generally comprising a disk operationally coupled to landscaping equipment. The disk is moved by the landscaping equipment. A blade is operationally coupled to the disk. The blade is moved by the disk so the blade may cut plant matter.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a interchangeable blade assembly according to an embodiment of the disclosure.

FIG. 2 is a top view of an embodiment of the disclosure.

FIG. 3 is a bottom perspective view of an embodiment of the disclosure.

FIG. 4 is a top perspective view of an embodiment of the disclosure.

### DESCRIPTION OF THE PREFERRED EMBODIMENT

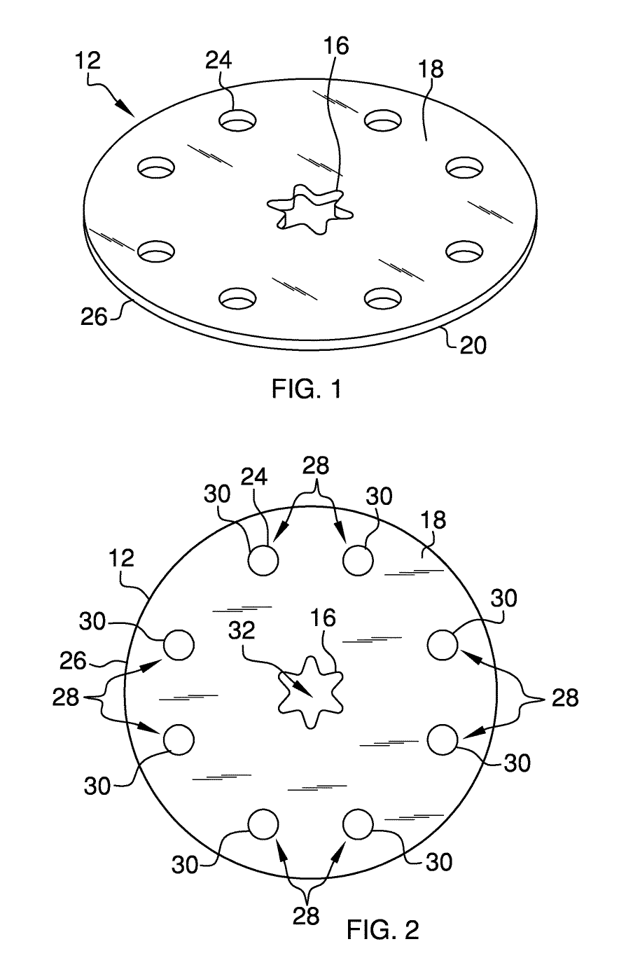

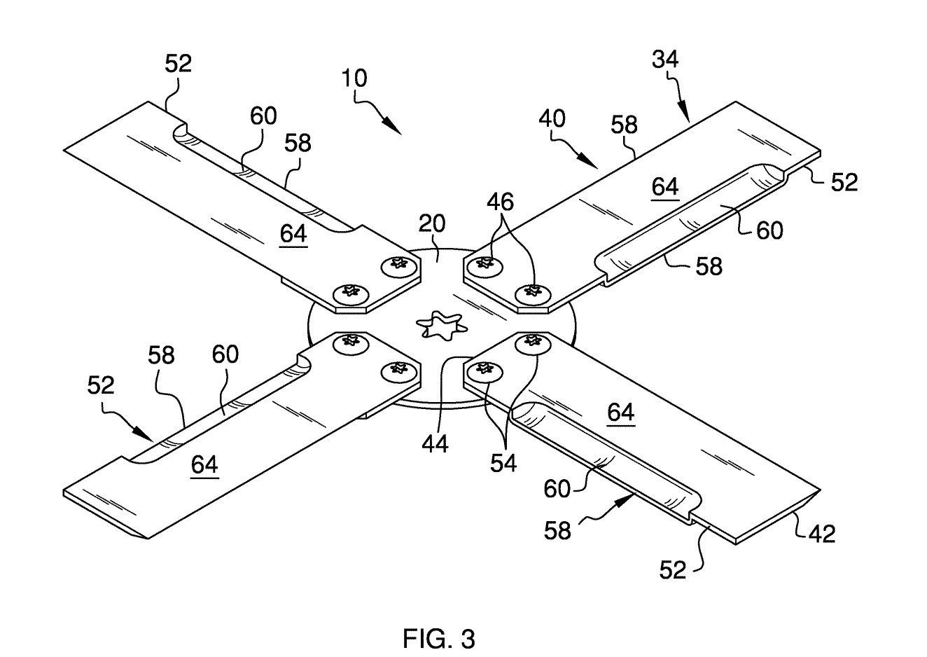

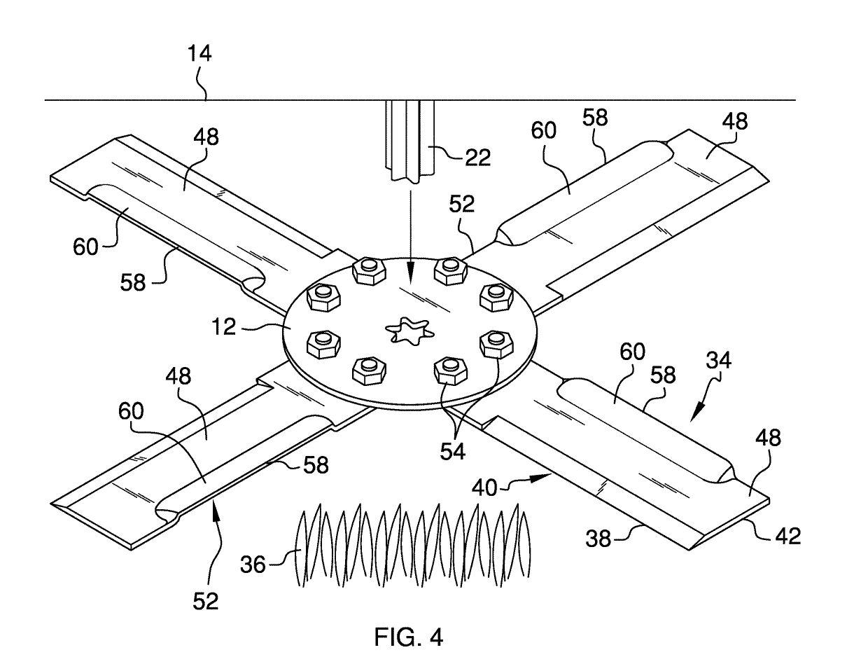

With reference now to the drawings, and in particular to FIGS. 1 through 4 thereof, a new interchangeable blade device embodying the principles and concepts of an embodiment of the disclosure and generally designated by the reference numeral 10 will be described.

As best illustrated in FIGS. 1 through 4, the interchangeable blade assembly 10 generally comprises a disk 12 operationally coupled to a piece of landscaping equipment 14. The disk 12 may be moved by the landscaping equipment 14. Further, the landscaping equipment 14 may comprise a lawnmower of any conventional design. Additionally, the disk 12 may have a diameter between 10 cm and 15 cm.

A centrally positioned drive shaft aperture 16 extends through a top side 18 and a bottom side 20 of the disk 12. Additionally, the centrally positioned drive shaft aperture 16 insertably receives a drive shaft 22 on the landscaping equipment 14 so the disk 12 is rotatably coupled to the drive shaft 22. The centrally positioned drive shaft aperture 16 may have a diameter between 11 mm and 16 mm. Moreover, the centrally positioned drive shaft aperture 16 may have either a star shape or a circular shape that corresponds to the shape of the drive shaft 22.

A primary fastener aperture 24 extends through the top side 18 and the bottom side 20 of the disk 12. The primary fastener aperture 24 is positioned proximate an outer edge 26 of the disk 12. Further, the primary fastener 24 may have a diameter between 9 mm and 13 mm. The primary fastener aperture 24 is one of a plurality of the primary fastener apertures 24. Moreover, the plurality of primary fastener apertures 24 comprises a plurality of sets of the primary fastener apertures 28.

Each of the plurality of sets of the primary fasteners 28 comprises a pair of primary fastener apertures 30. Additionally, the pair of primary fastener apertures 30 is each evenly spaced apart from opposite sides of a longitudinal axis extending through a center 32 of the centrally positioned drive shaft aperture 16 and the outer edge 26 of the disk 12. The pair of primary fastener apertures 30 may be spaced apart a distance between 19 mm and 31 mm. Moreover, the plurality of sets of primary fastener apertures 28 is evenly distributed around four quadrants of the disk 12.

A plurality of blades 34 is operationally coupled to the disk 12 and radially arranged around and extending from the disk 12. Each blade 34 is moved by the disk 12 so the blade 34 may cut plant matter 36. Moreover, the plant matter 36 may comprise grass. The blade 34 may have a length between 25 cm and 38 cm and a width between 5 cm and 10 cm. A leading edge 38 of the blade 34 tapers to a point so a cutting portion 40 of the blade 34 is defined. The cutting portion 40 of the blade 34 extends between a free end 42 of the blade 34 and a point closer to a coupled end 44 of the blade 34 than the free end 42 of the blade 34. The cutting portion is coplanar with a bottom face 64 of the blade 34. The leading edge 38 of the blade 34 cuts the plant matter 36 when the disk 12 is rotated. A trailing edge 52 of each blade 34 has an offset medial portion 58 defining a scoop 60 in the blade 34 extending back from the cutting portion 40 of the blade 34. Each blade 34 is coupled to abut a first face 62 of the disk 12. Each scoop extends upwardly relative to a top side 48 of the blade 34.

Each blade 34 has a pair of secondary fastener apertures 46 extending through the top side 48 and a bottom side 50 of the blade 34 proximate the coupled end 44 of the blade 34. Moreover, each of the pair of secondary fastener apertures 46 is positioned proximate an associated one of the leading edge 38 and the trailing edge 52 of the blade 34. Each of the pair of secondary fasteners 46 may have a diameter between 9 mm and 13 mm. Lastly, the pair of secondary fasteners 46 may be spaced apart a distance between 19 mm and 31 mm.

Each blade 34 is coupled to the disk 12 so the top side 48 of the blade 34 abuts the bottom side 20 of the disk 12. Additionally, the pair of secondary fastener apertures 46 is aligned with each of an associated one of the plurality of sets of primary fastener apertures 28. A pair of fasteners 54 extends through each of the pair of secondary fastener apertures 46 and an associated one of the plurality of sets of primary fastener apertures 28. The pair of fasteners 54 retains the blade 34 on the disk 12 such that the free end 42 of the blade 34 is positioned laterally away from the outer edge 26 of the disk 12. The pair of fasteners 54 may comprise a nut and bolt of any conventional design.

Each of the plurality of blades 34 is aligned with an associated one of a plurality of sets of fastener apertures 28 in the disk 12. Additionally, the plurality of blades 34 forms a cross shape when the plurality of blades 34 is coupled to the disk 12. Lastly, the leading edge 38 of each of the plurality of blades 34 faces the trailing edge 52 of an associated one of the plurality of blades 34.

In use, the disk 12 is coupled to the drive shaft 22 on the landscaping equipment 14. Each of the plurality of blades 34 is coupled to the disk 12. The assembly 10 is used for cutting grass or for mulching. When the cutting portion 40 of the blade 34 becomes dulled from use, the blade 34 is removed and the cutting portion 40 of the blade 34 is sharpened.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure.

I claim:

1. An interchangeable blade assembly for quickly coupling a plurality of blades on landscaping equipment, said assembly comprising:
a disk operationally coupled to the landscaping equipment wherein said disk is configured to be moved by the landscaping equipment; and
a blade operationally coupled to said disk wherein said blade is moved by said disk wherein said blade is configured to cut plant matter, said blade having a cutting portion along a leading edge of said blade, a trailing edge of said blade having an offset medial portion defining a scoop in the blade extending back from the cutting portion of the blade.

2. The assembly according to claim 1, further comprising a centrally positioned drive shaft aperture extending through a top side and a bottom side of said disk.

3. The assembly according to claim 2, further comprising said centrally positioned drive shaft aperture insertably receiving a drive shaft on the landscaping equipment wherein said disk is rotatably coupled to the drive shaft.

4. The assembly according to claim 1, further comprising a primary fastener aperture extending through a top side and a bottom side of said disk wherein said primary fastener aperture is positioned proximate an outer edge of said disk.

5. The assembly according to claim 4, further comprising said primary fastener aperture being one of a plurality of said primary fastener apertures.

6. The assembly according to claim 5, further comprising said plurality of primary fastener apertures comprising a plurality of sets of said primary fastener apertures.

7. The assembly according to claim 6, further comprising each of said plurality of sets of said primary fasteners comprising a pair of primary fastener apertures being evenly spaced apart from opposite sides of a longitudinal axis extending through a center of a centrally positioned drive shaft aperture and an outer edge of said disk.

8. The assembly according to claim 7, further comprising said plurality of sets of said primary fastener apertures being evenly distributed around four quadrants of said disk.

9. The assembly according to claim 1, further comprising a leading edge of said blade tapering to a point wherein said cutting portion of said blade is defined.

10. The assembly according to claim 1, further comprising said cutting portion of said blade extending between a free end of said blade and a point closer to a coupled end of said blade than said free end of said blade.

11. The assembly according to claim 1, further comprising a pair of secondary fastener apertures extending through a top side and a bottom side of said blade proximate a coupled end of said blade wherein each of said pair of secondary fastener apertures is positioned proximate an associated one of a leading edge a trailing edge of said blade.

12. The assembly according to claim 1, further comprising said blade being coupled to said disk wherein a top side of said blade abuts a bottom side of said disk wherein a pair of secondary fastener apertures is aligned with each of an associated one of a plurality of sets of primary fastener apertures.

13. The assembly according to claim 1, further comprising a pair of fasteners extending through each of a pair of secondary fastener apertures and an associated one of a plurality of sets of primary fastener apertures wherein said blade is retained on said disk such that a free end of said blade extends laterally away from an outer edge of said disk.

14. The assembly according to claim 1, further comprising said blade being one of a plurality of said blades being aligned with an associated one of a plurality of sets of fastener apertures in said disk.

15. A interchangeable blade assembly for quickly coupling a plurality of blades on landscaping equipment, said assembly comprising:
a disk operationally coupled to the landscaping equipment wherein said disk is configured to be moved by the landscaping equipment;
a centrally positioned drive shaft aperture extending through a top side and a bottom side of said disk, said centrally positioned drive shaft aperture insertably receiving a drive shaft on the landscaping equipment wherein said disk is rotatably coupled to the drive shaft;
a primary fastener aperture extending through said top side and said bottom side of said disk wherein said primary fastener aperture is positioned proximate an outer edge of said disk, said primary fastener aperture being one of a plurality of said primary fastener apertures;
said plurality of primary fastener apertures comprising a plurality of sets of said primary fastener apertures, each of said plurality of sets of said primary fasteners comprising a pair of primary fastener apertures being evenly spaced apart from opposite sides of a longitudinal axis extending through a center of said centrally positioned drive shaft aperture and said outer edge of said disk, said plurality of sets of said primary fastener apertures being evenly distributed around four quadrants of said disk;
a blade operationally coupled to said disk wherein said blade is moved by said disk wherein said blade is configured to cut plant matter, a leading edge of said blade tapering to a point wherein a cutting portion of said blade is defined, said cutting portion of said blade extending between a free end of said blade and a point closer to a coupled end of said blade than said free end of said blade, a trailing edge of said blade having an offset medial portion defining a scoop in the blade extending back from the cutting portion of the blade;
a pair of secondary fastener apertures extending through a top side and a bottom side of said blade proximate said coupled end of said blade wherein each of said pair of secondary fastener apertures is positioned proximate an associated one of said leading edge a trailing edge of said blade;
said blade being coupled to said disk wherein said top side of said blade abuts said bottom side of said disk wherein said pair of secondary fastener apertures is aligned with each of an associated one of said plurality of sets of primary fastener apertures;
a pair of fasteners extending through each of said pair of secondary fastener apertures and an associated one of said plurality of sets of primary fastener apertures wherein said blade is retained on said disk such that said free end of said blade extends laterally away from said outer edge of said disk; and
said blade being one of a plurality of said blades being aligned with an associated one of a plurality of sets of fastener apertures in said disk.
